(19) United States
(12) Patent Application Publication
(10) Pub. No.: US 2006/0013108 A1
(43) Pub. Date: Jan. 19, 2006

(54) Information storage system and method

(76) Inventors: Ian Andrew Maxwell, New South Wales (AU); Mark Andrew Englund, New South Wales (AU)

Correspondence Address: CHAPIN & HUANG L.L.C.;WESTBOROUGH OFFICE PARK, 1700 WEST PARK DRIVE, WESTBOROUGH, MA, 01581, US

(21) Appl. No.: 11/167,942

(22) Filed: Jun. 27, 2005

(30) Foreign Application Priority Data
Jun. 25, 2004 (AU) 2004903485

(51) Int. Cl. G11B 7/00

(52) U.S. Cl. 369/112.01

(57) ABSTRACT

A data storage device comprising: a photosensitive optical waveguide having a predetermined structure photosentively formed therein; a package for mounting the waveguide on; an optical interface interconnected to the waveguide and adapted to temporarily attach to optical interrogation devices for receiving optical signals for interrogation of the optical properties of the predetermined structure.

### PRIORITY TO EARLIER FILED APPLICATION

This application claims the benefit to earlier filed Australian Patent Application No.: 2004903485 filed on Jun. 25, 2004 and that shares co-inventorship herewith. The entire teachings, figures and contents of this Australian application are hereby incorporated by reference herein.

### FIELD OF THE INVENTION

The present invention relates to the field of optical storage mechanisms and, in particular, discloses an optical ROM storage device and associated distribution mechanisms.

### BACKGROUND OF THE INVENTION

The distribution of information such as music, videos etc. has increasingly become by way of CD or DVD ROM Discs. The disc market has become extremely large however it is not without detrimental side effects. These can include:
That footprint of these devices is large for the memory storage capacity.
Whilst storage capacity on these devices is increasing with new technologies (eg blue lasers), compression technologies (eg MP3, AAC for music) mean that less storage capacity is often needed.
Optical disks often suffer from durability problems, such as scratches and grease smudging, which leads to incorrect reading of content and user dissatisfaction.
These devices all require a motor to spin a disc. This is expensive, leads to device failure, but most critically leads to limited battery life in mobile consumer electronic devices.
These formats are often open-source in that any user can copy these formats. This has lead to significant piracy in the music and video industries.
It has become possible to distribute music and video content (that was originally distributed by CD-ROM) by the Internet, and this fact has lead to significant piracy of content (the music industry lost an estimated US$700m in 2002).
Mobile (untethered) electronic consumer devices have emerged as the driver behind both the desire for rich content (eg more than just music; fan data, music sheets etc) and adaptability (the ability to transfer content from device to device).

There exists a market for new forms of ROM devices. Possible devices include a solid state semi conductor ROM which is normally quite expensive. CD ROMs on the other hand have become very inexpensive in recent years and DVD ROMs are also quite inexpensive. In order to be highly attractive, to industries such as the music industry, a new form of ROM device should have the following characteristics:
Cost of ROM chip: less than $1 is in the upper range of what is tolerable. Lower costs are even more desirable.
Manufacturing turnaround time—for efficient manufacturing and distribution it needs to take less than 72 hours from receipt of master to finished product being shipped
Non-Recurring Engineering (NRE) cost per title needs to be less than about $5k per title.
Capacity in the first instance needs to be about 256 Mbytes—enough for an album of compressed audio, with still images and text. Thereafter higher data capacities would be useful.
Additionally, it is expected that the ROM chip format will be in the Multi-Media Card (MMC) format as one possible physical standard. The MMC card is an industry standard format that is a smaller footprint relative to optical disks.
Reading rates must be sufficient to allow real time streaming of music and video to the listener.
Durability and environmental requirements at least the same as for CD's

A large number of possible applications for storage are possible. For example, music CDs, Movie DVDs games, archive materials, publication and images can all be stored readily on such a storage device.

### SUMMARY OF THE INVENTION

It is an object of the present invention to provide for an improved or alternative form of digital media distribution.

In accordance with a first aspect of the present invention, there is provided a data storage device comprising: a photosensitive optical waveguide having a predetermined structure photosensitively formed therein; a package for mounting the waveguide on; a light source and light detector for creating and then receiving optical signals from the pre-determined structures in the optical waveguides, for interrogation of the optical properties of the predetermined structure.

In one embodiment, the light source and light detector are preferably incorporated unitarily into the data storage device. Alternatively, either, or both of the light source and light receiver are preferably placed externally to the data storage device, and connected to the data storage device when required by means of an optical connector.

The device can also include a blazed grating structure for sending signals to and/or extracting signals from the optical waveguide. The predetermined structure can comprise a periodic structure such as a Bragg grating structure. The periodic structure can be modified in a predetermined way so as to alter the frequency response of the grating structure. The modifications can include phase or amplitude modifications of the frequency response.

The optical waveguide can comprise an optical fibre or a planar optical waveguide. The predetermined structure can be utilised to store information in a digital or analog manner.

In accordance with a further aspect of the present invention, there is provided a method of forming a data storage device comprising the steps of: (a) writing a predetermined optical structure into a series of photosensitive waveguides; (b) attaching the written photosensitive waveguide to a first optical interface; (c) mounting the waveguide and attached interface on a handheld portable module.

The method can also include the steps of: (d) providing a second optical interface to interconnect to the first optical interface; (e) interrogating the optical properties of the photosensitive waveguide; (f) determining from the optical properties, a corresponding data set; (g) outputting the corresponding data set.

### BRIEF DESCRIPTION OF THE DRAWINGS

Preferred forms of the present invention will now be described with reference to the accompanying drawings in which:

FIG. 1 illustrates the mounting of an optical fibre on a package substrate;

FIG. 2 illustrates the process of writing multiple fibres simultaneously;

FIG. 3 illustrates the steps involved in creating devices in accordance with the preferred embodiment.

FIG. 4 illustrates schematically a ROM device with laser and receiver in a package, and electrical connection to ROM device;

FIG. 5 illustrates schematically a ROM device with a laser and receiver (either incorporated in the ROM package) or external to the ROM package, and a blaze grating in the optical fibre.,

FIG. 6 illustrates schematically a ROM device with a laser and receiver (either incorporated in the ROM package) or external to the ROM package, an optical lens for focusing light onto and from the optical fibre, and a blazed grating in the optical fibre.,

### DESCRIPTION OF PREFERRED AND OTHER EMBODIMENTS

In the preferred embodiment, a new form of ROM type distribution media is proposed. The distribution media consists of short lengths of photosensitive optical fibre or other optical waveguides (eg planar waveguides) onto which a uniquely coded periodic structures (including but not limited to Bragg gratings) has been written or induced.

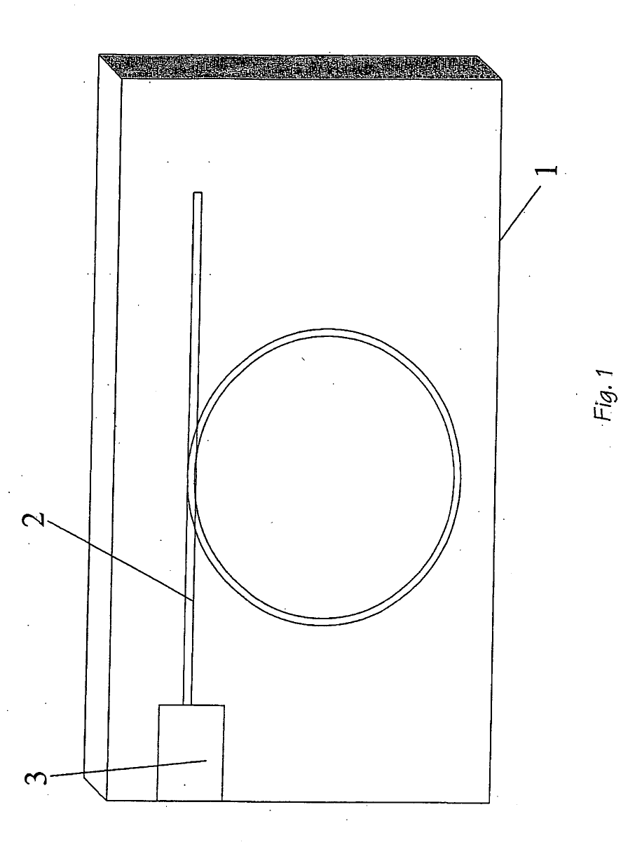

Turning initially to FIG. 1, there is illustrated an example of the packaging 1 of a coiled length of optical fibre 2 which is interconnected to an optical coupling device 3 for interrogation of the optical fibre 2. The fibre 2 is a UV sensitive fibre on which a Bragg grating structure has been previously written. The fibre 2 has then been mounted on the package 1 interconnected to the coupling 3.

The writing of Bragg grating structures into a photo sensitive fibre is a well known art. Techniques are disclosed for example in U.S. Pat. No. 5,818,988 to Modavis, U.S. Pat. No. 6,414,764 to Ouellette, , U.S. Pat. No. 5,712,715 to Erdogen, , U.S. Pat. No. 5,377,288 to Kashyap et al. and U.S. Pat. No. 5,327,515 to Anderson et al. Methods for providing for controlled alterations in the properties of Bragg gratings are known. For example, reference is made to PCT International Patent Application Number PCT/AU99/00417 to Stepanov et al and PCT International Patent Application Number PCT/AU99/00403 to Poladian et al the contents of which are hereby incorporated by cross-reference.

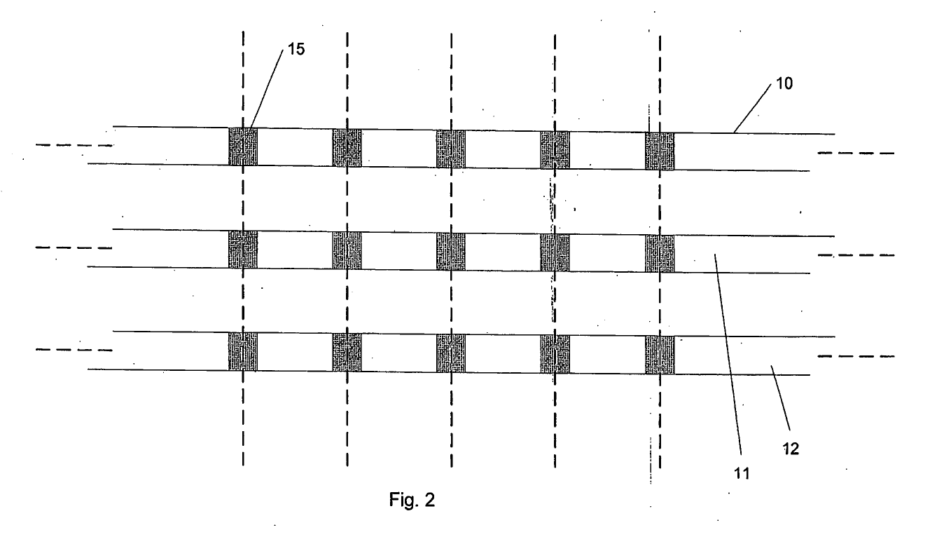

Although many different techniques can be utilised, the preferred technique, as outlined in the aforementioned PCT applications, is to form an interference pattern derived from a UV laser device and to imprint the pattern in to the core of the photo sensitive fibre. An example of this process is illustrated schematically in FIG. 2, where a series of photosensitive fibres 10-12 are aligned and a series of changes in refractive index e.g. 15 are written into the fibre by means of a UV laser. After the Bragg structures have been written, the fibres are then mounted on a package such as that shown in FIG. 1.

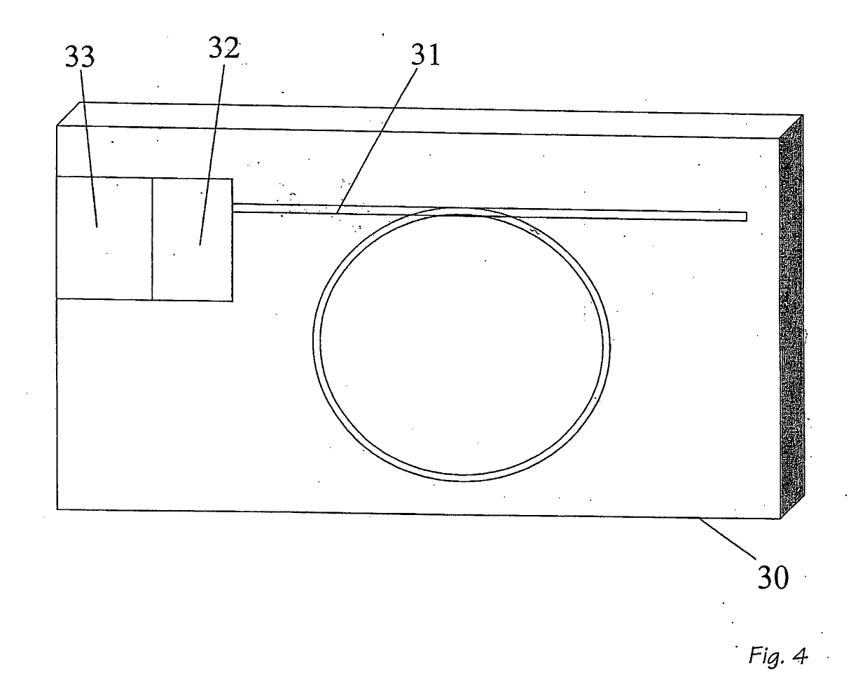

An alternative embodiment is described in FIG. 4, there is illustrated an example of the packaging 30 of a length of optical fibre 31 which is interconnected to an opto-electronic device 32 containing a light source and light receiver, for interrogation of the optical fibre 31. The fibre 31 is a UV sensitive fibre on which a Bragg grating structure has been written. The fibre 31 has then been mounted on the package 30 and interconnected to the opto-electronics device 32, which in turn can be connected to an external electronic interpretation device via electrical coupling 33. In this embodiment, the packaged fiber device 30 can also contain the laser and optical detector required to interpret the information stored on the optical fiber. In this case there is no requirement for an optical connector in the ROM package. The input and output to the ROM package can therefore be entirely electrical in this instance. The choice of mounting the optical interpretation in the ROM package or in the device that accepts the ROM package can be made on a variety of issues, such as the relative cost of optical connectors to lasers and receivers, the benefits associated with using existing packages for memory chips that utilize electrical connectors, etc.

It is known how to write a Bragg grating structure having a predetermined frequency response. In the preferred embodiment, the unique frequency response is utilised to store information. The Bragg grating structure is divided into a series of n channels that correspond to different wavelengths. Using a multilevel coding scheme such as phase amplitude shift keying, each bit of a bit sequence may be converted into a specific phase/amplitude coordination code in a phase/amplitude coordinate system. A Bragg grating having the specific phase and amplitude properties may then be written using conventional techniques.

For example, each channel of the multi-channel grating may have a number of possible different phase and amplitude levels. Further, each channel may have a number of wavelength divisions. In a specific example, there is assumed to be 8 channels with each channel having 8 possible phase levels, 8 possible amplitude levels and 5 wavelengths divisions. Therefore, the number of possible combinations is 8×8×8×5=25920 and a grating of this type can store one of 25920 different encoded bit sequences. It will be appreciated that the number of channels, amplitude levels, phase levels, and wavelength divisions may alternatively be significantly larger (or smaller) than those in the specific example. The Bragg grating thus is a read-only memory that has a memory size which depends on these parameters. For example, the grating may be arranged to have a memory size of several Mb or more. While there is probably a limit to the memory density per unit length of optical fiber, the ultimate memory density is also only limited by the length of optical fiber that is utilised in each ROM device, with larger memory capacity utilising more of the fibre.

To read the read only memory, a laser may be used such as a multi-longitudinal mode Fabry Perot semiconductor laser. In this form of reading, the laser has resonances that correspond to the channels of the grating. The laser may generate a square pulse which is directed through the fibre core to the grating. The laser light will experience amplitude and phase changes and a portion of the pulse is reflected by the grating. Owing to the amplitude and phase changes, the envelope of the pulse will be changed. The reflected light is then detected by a photodetector and converted into an electrical signal. The converted signal is then sampled and processed by a microprocessor to retrieve the information that is encoded in the Bragg grating.

Alternatively, a tunable laser may be used to generate the optical radiation. The wavelength of the laser may be scanned across the channels of the multi-channel grating. A phase and amplitude sensitive detector detects the optical signal that is reflected from the multi-channel grating. In a multi-level decoding sequence the signal may be decoded and the information retrieved.

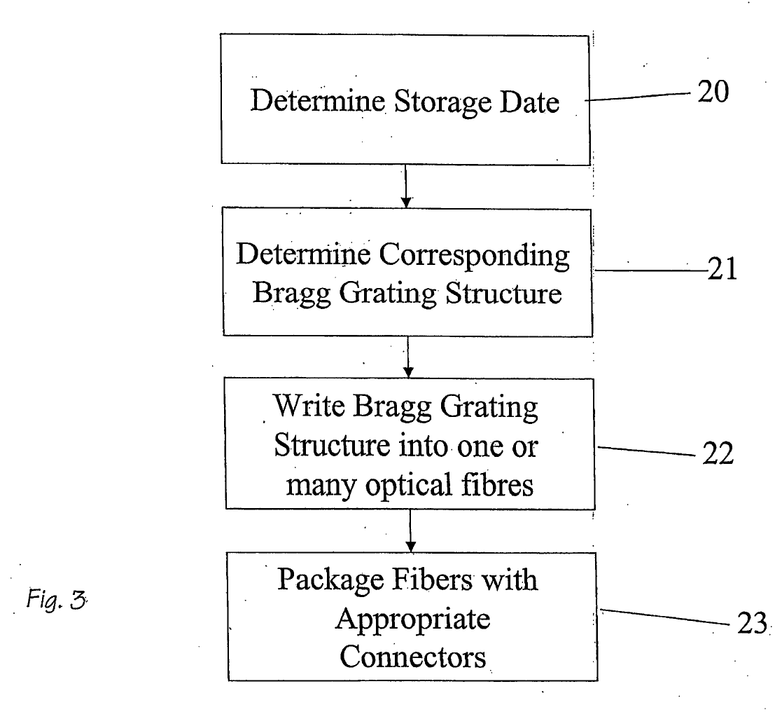

The steps for the creation of the preferred embodiment can then be as set out in FIG. 3. These can include a first step 20 of determining the storage data requirements. Next a corresponding Bragg grating structure 21 is determined, this is then written into the fibre 22 and the fibre packaged 23.

In one form of the preferred embodiment a music album in a digital data format (for example) is stored on specially written section of optical fiber (the data storage medium), the fibre is mounted in a housing to protect the fiber from the environment, and a connector is provided to connect the fiber to a device. The device (say a consumer electronic mobile music player) contains a laser and a receiver and controlling electronics and algorithms to interpret the fiber in order to receive the memory data (say music track) for further amplification and playing.

Initially, it is envisage that the data is stored in a small diameter optical fiber. This is proven technology, and the small diameter fiber can be coiled into a small diameter package. In an alternative embodiment, planar optical waveguides can be used to store data, and even stacked planar waveguides. This allows for even lower costs and higher memory density.

Rather than having a laser interpreting a single spot in an optical storage medium (as in a CD), the laser interrogates the memory imprinted in the optical waveguide via the optical waveguide, a distinctly different and novel approach to optical memory that has significant advantages. The laser simultaneously retrieves information from the entire length of the optical waveguide resulting in high bandwidth retrieval. By this means, the necessity to spin an optical storage media and/or move a laser is entirely obviated. Therefore the electrical power required to retrieve data is minimized. Additionally the optical storage media is protected from the environment by the fiber cladding and physical package of the module - this can be significantly more robust and durable than optical disk technology where the optical storage media is necessarily exposed.

The reflected field in the preferred embodiments is read by a detector closely coupled to the waveguide (ie. not read from a radiated field as with Compact Disk devices). As a consequence, a large optical signal to noise ratio facilitates a multilevel encoding scheme with a significant number of quantisation levels. This provides the potential for a large memory image with a small address range (in contrast to CD where the physical address range is huge (5 km of track) and the encoding depth is very small (two level encoding)), leading to an advantage of very rapid access times.

Advantageously, the technology required to write sufficiently high memory density structures into an optical fiber is not commonly available and the so called fiber-Bragg-grating-read-only-memory (FBG-ROM) itself is difficult to reverse engineer. Hence this form storage provides a degree of security against home users and groups wishing to create pirate copies of copyrighted material.

The technology can also be created with an inherently low cost. The package can be a simple plastic housing. The optical fiber costs are of the order of cents per meter, and only a centimetre or a few centimetres is required per music album. Low cost connectors, lasers and receivers are becoming available for optical fibers. Unlike the two dimensional CD-ROM technology, as illustrated in FIG. 3, many single-dimension lengths of fibre can be exposed simultaneously to the UV laser beams of the printing system for rapid mass production of the ROM image. Tools for processing optical fibre ribbons (multiple fibres joined side by side) are well developed.

Different encoding schemes can be utilised. In other embodiments, all the properties of the optical field and the waveguide can be utilised including: Wavelength; Optical phase and optical group delay; polarisation state and waveguide birefringence (including UV induced and intrinsic waveguide birefringence), ie. rocking filters; optical gain and/or loss—complex refractive index (refractive index as a function of population inversion); transverse modes (ie. multimode fibres) or longitudinal modes (ie. resonant cavities); and electro-optic coefficients (ie. poled fibres).

Conventional step index single mode fibres and/or multimode fibres are initially preferred to be used but other waveguide types where the guiding properties of waveguide can be tailored or modified in-situ, such as photonic crystal fibres where the optical field is guided by a band-gap structure in the transverse axis of the fibre, may also be exploited to achieve enhanced optical performance (ie. memory density or wavelength range over which the waveguide is single mode) or lower unit cost. Other embodiments may use a few of the coding dimensions only. These can include: 1) wavelength band 2) amplitude as a function of wavelength in given band 3) optical phase as a function of wavelength in given band and 4) time of flight which is equivalent to the position of the given data storage element (wavelength band) in the fibre.

It will be appreciated that most modem data storage involves storage of digital data, to which the current technology is ideally suited. However, this technology is also suited to data analog storage, which can have particular advantages for music with regards to fidelity of reproduction. The detection equipment can also be varied in accordance with requirements. These can include a variable wavelength, tunable laser sources with a splitting, filtering or lensing systems to separate the interrogation field from the reflected field. Another forms of detector could comprise a time domain pulsed laser and high speed photo-receiver again with a splitter, filter or lensed systems to separate the interrogation field from the reflected field. Alternatively, a combination of the two could be used, or other means can be considered

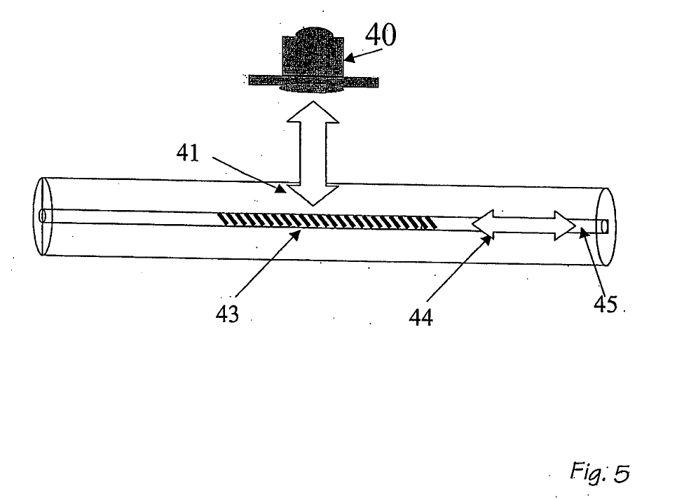

Another means of sending light to and/or detecting the light from reflective gratings can be to have a blazed grating at the beginning of the fiber, whose role is to either send light to the optical fibre, and/or reflect the returned light into a photo-detector placed either external to the packaged ROM device, or in the packaged ROM device. One such an arrangement is illustrated schematically in FIG. 5, wherein light is projected 41 onto the fibre core from the light source 40, where it interacts with a blazed grating 43 formed within the core, from where it is reflected into the core of the 44 and transported down the core 44. Similarly the return light 45, interacts with a blazed grating 43 formed within the core. One of the radiation modes is orthogonal to the core where light is emitted for detection by a detector 40.

The advantage of the blazed grating is that light can be put onto and removed from the optical fibre without the need for an expensive high cost optical connector, which generally have difficult tolerance in manufacturing and assembly, sometimes in the sub-micron range.

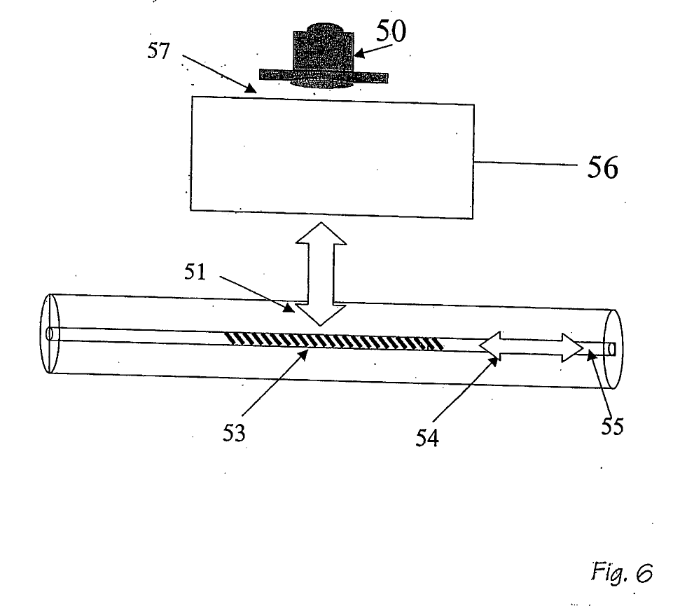

Additionally, a lens can be used, if required, to focus light between the blazed grating in the optical fibre and the light source and/or receiver. By the use of such a lens the tolerances of alignment between the light source and/or receiver and the optical fibre may be lowered, and this may gain significant cost advantages. Such a lens can be made from low cost plastics, glass or other materials. It is further noted that the light source and/or light receiver and/or the lens may either be incorporated in the packed ROM device, or external to the packaged ROM device. An example of such a device is illustrated in FIG. 6, wherein light is projected 57 into a lens 56 from the light source 50, where it is focused onto the fibre core 51. There it interacts with a blazed grating 53 formed within the core, from where it is reflected into the core of the 54 and transported down the core 54. Similarly the return light 55 interacts with a blazed grating 53 formed within the core. One of the radiation modes is orthogonal to the core where light is emitted 51 to the lens 56 and focused 57 into detector 50.

The blazed grating can be constructed with a relatively broadband response (spectral features of 10's of nm compared to 0.05 nm for a conventional fibre bragg grating (FBG) channel width) and the polarisation sensitivity of a blazed Bragg grating's efficiency in coupling a core bound mode to a radiation mode that a detector close to the fibre may read. If the cost advantages are significant enough the demodulation approach may be rearranged to accommodate these characteristics. Conversely, the same approach can be used to provide potentially robust and very cheap coupling to a core bound mode from an optical source positioned orthogonal to the axis of the fibre length in the vicinity of a suitably designed blazed FBG.

The light source (laser) and detection equipment can either be incorporated in the module itself or in separate light source and detection equipment.

Significantly, prior art devices do not use the advantageous method of writing custom Bragg gratings into photosensitive fibers to form the data storage medium. The use of photosensitive methods allow for multiple fibres to be formed simultaneously in a optical interference region overlaying a series of photosensitive waveguides. Further, the use of custom Bragg gratings allow for multiple optical parameters to be exploited to encode or address the information, thereby allowing for multi level encoding schemes, compared to the single level encoding schemes of Compact Disk devices.

The foregoing describes preferred forms of the invention, modifications obvious to those skilled in the art can be made thereto without departing from the scope of the invention.

1. A data storage device comprising:
a photosensitive optical waveguide having a predetermined structure photosensitively formed therein;
a package for mounting said waveguide on;
a light source and light detector for creating and then receiving optical signals from the pre-determined structures in the optical waveguides, for interrogation of the optical properties of said predetermined structure.

2. A data storage device as claimed in claim 1 wherein the light source and light detector are incorporated unitarily into the data storage device.

3. A data storage device as claimed in claim 1 wherein either, or both of the light source and light receiver are placed externally to the data storage device, and connected to the data storage device when required by means of an optical connector.

4. A data storage device as claimed in claim 1 further including a blazed grating structure for sending signals to and/or extracting signals from the optical waveguide.

5. A data storage device as claimed in claim 4 further including an optical lens for focusing light between the blazed grating structure in the optical fibre and light source and/or light receiver.

6. A data storage device as claimed in claim 1 wherein said predetermined structure includes predetermined modulation of at least one of the following responses of the waveguide including: Wavelength; Optical phase, optical group delay; polarisation response, waveguide birefringence response, waveguide filter response; transverse mode response; longitudinal mode response or electro-optic coefficient response.

7. A data storage device as claimed in claim 1 wherein said predetermined structure comprises a periodic structure.

8. A data storage device as claimed in claim 7 wherein said periodic structure comprises a Bragg grating structure.

9. A data storage device as claimed in claim 7 wherein said periodic structure is modified in a predetermined way so as to alter the frequency response of the grating structure.

10. A data storage device as claimed in claim 9 wherein said modifications include phase or amplitude modifications of the frequency response.

11. A data storage device as claimed in claim 1 wherein said optical waveguide comprises an optical fibre.

12. A data storage device as claimed in claim 1 wherein said optical waveguide comprises a planar optical waveguide.

13. A data storage device as claimed in claim 1 wherein said predetermined structure is utilised to store information in a digital or analog manner.

14. A data storage device including:
a photosensitive optical waveguide having a predetermined structure photosensitively formed therein;
a package for mounting said waveguide on;
an optical interrogation means mounted on said package for interrogation of the optical properties of said predetermined structure and determination of corresponding information;
a communications interface for communication of said information to external devices.

15. A data storage device as claimed in claim 1 wherein said device is utilised to store music or video data.

16. A method of forming a data storage device comprising the steps of:
(a) writing a predetermined optical structure into a series of photosensitive waveguides;
(b) attaching the written photosensitive waveguide to a first optical interface;
(c) mounting the waveguide and attached interface on a handheld portable module.

17. A method as claimed in claim 16 further comprising the step of:
(d) providing a second optical interface to interconnect to said first optical interface;
(e) interrogating the optical properties of said photosensitive waveguide;
(f) determining from said optical properties, a corresponding data set;
(g) outputting said corresponding data set.

18. A method as claimed in claim 16 wherein said data set includes one of a music file or a video file. devices. 15. A data storage device as claimed in claim I wherein said device is utilised to store music or video data. 16. A method of forming a data storage device comprising the steps of:
(a) writing a predetermined optical structure into a series of photosensitive waveguides;
(b) attaching the written photosensitive waveguide to a first optical interface;
(c) mounting the waveguide and attached interface on a handheld portable module. 17. A method as claimed in claim 16 further comprising the step of:
(d) providing a second optical interface to interconnect to said first optical interface;
(e) interrogating the optical properties of said photosensitive waveguide;
(f) determining from said optical properties, a corresponding data set;
(g) outputting said corresponding data set. 18. A method as claimed in claim 16 wherein said data set includes one of a music file or a video file.
